(19) United States
(12) Patent Application Publication
(10) Pub. No.: US 2018/0356583 A1
(43) Pub. Date: Dec. 13, 2018

(54) SIDE-LIGHTING LIGHT GUIDE PLATE AND BACKLIGHT MODULE

(71) Applicant: WUHAN CHINA STAR OPTOELECTRONICS TECHNOLOGY CO., LTD., Wuhan, Hubei (CN)

(72) Inventors: Xiaoling LI, Wuhan, Hubei (CN); Chao LIANG, Wuhan, Hubei (CN)

(21) Appl. No.: 15/571,279

(22) PCT Filed: Jun. 22, 2017
(86) PCT No.: PCT/CN2017/089618

§ 371 Date: Nov. 2, 2017

(30) Foreign Application Priority Data
May 19, 2017 (CN) 201710357150.1

(51) Int. Cl. F21V 8/00

(52) U.S. Cl. CPC G02B 6/0028; G02B 6/0068

(57) ABSTRACT

This disclosure provides a side-lighting light guide plate and a backlight module. The side-lighting light guide plate comprises a light guide component having a first light incident surface and a light emitting surface that intersects with the first light incident surface; a plurality of first light guide columns disposed on the first light incident surface to guide light into the light guide component; the light emitting surface configured to emit the light.

### BACKGROUND OF THE INVENTION

### 1. Field of the Invention

The present disclosure relates to the manufacturing field of liquid crystal display panels, and more particularly to a side-lighting light guide plate and a backlight module.

### 2. Description of the Prior Art

Displays are used for reproducing the real word as the way eyes see. Main displays comprise liquid crystal displays (LCDs) and organic light-emitting diode displays (OLEDs). The liquid crystal display has a long development history and has advantages of mature process, low cost, and high reliability. LCDs illuminate through all-full-lighting backlight or almost-full-lighting backlight, and drive liquid crystals by thin-film transistors as optical shutters, to adjust brightness of sub-pixels.

A backlight module is an important component of an LCD panel. Local dimming function of the backlight module can improve contrast ratio of the LCD panel and reduce power consumption. Implementation of the local dimming function is influenced by a light guide plate, which is an important component of the backlight module. The light guide plate is a high-tech product that changes a light source from a thread light source to a planar light source, and is designed according to LCDs of laptops. Base material of the light guide plate is optical acrylic. The light guide plate changes from a thread light source to a planar light source by improving light transmittance of a light guide point according to backlight modules of LCD panels and laptops.

Light rays from a light source disposed on a side of the light guide plate enter a light incident surface of the light guide plate making a big bright area of the light guide plate and a poor local dimming for the reason that the light rays cannot be guided together.

As a result, it is necessary to solve the problems of existing techniques.

### SUMMARY OF THE INVENTION

The present disclosure provides a improved side-lighting light guide plate and a improved backlight module.

To solve the above problem, the present disclosure provides a technical scheme as follows:

The present disclosure provides a side-lighting light guide plate, the side-lighting light guide plate comprises a light guide component having a first light incident surface and a light emitting surface that intersects with the first light incident surface;
a plurality of first light guide columns disposed on the first light incident surface to guide light into the light guide component;
the light emitting surface configured to emit the light.

According to a preferred embodiment of the present disclosure, the plurality of first light guide columns are perpendicular to the first light incident surface.

According to a preferred embodiment of the present disclosure, the plurality of first light guide columns are parallel to the light emitting surface and are sequentially arranged on the first light incident surface.

According to a preferred embodiment of the present disclosure, the plurality of first light guide columns are disposed along a same interval.

According to a preferred embodiment of the present disclosure, the plurality of first light guide columns are cylindrical.

According to a preferred embodiment of the present disclosure, a length of the plurality of first light guide columns is 5-10 times of a width of a bottom of the plurality of first light guide columns.

According to a preferred embodiment of the present disclosure, the light guide component has a second light incident surface that intersects with the light emitting surface;
the plurality of first light guide columns and/or a plurality of second light guide columns disposed on the second light incident surface, to guide light into the light guide component;
the light emitting surface configured to emit the light.

According to a preferred embodiment of the present disclosure, the first light incident surface is parallel to the second light incident surface.

According to a preferred embodiment of the present disclosure, the plurality of second light guide columns are perpendicular to the second light incident surface.

According to a preferred embodiment of the present disclosure, the plurality of second light guide columns are parallel to the light emitting surface and are sequentially distributed on the second light incident surface.

According to a preferred embodiment of the present disclosure, the plurality of second light guide columns are disposed along a same interval.

According to a preferred embodiment of the present disclosure, the plurality of second light guide columns are cylindrical.

According to a preferred embodiment of the present disclosure, a length of the plurality of second light guide columns is 5-10 times of a width of a bottom of the plurality of second light guide columns.

According to a preferred embodiment of the present disclosure, the side-lighting light guide plate comprises a light guide component haying a first light incident surface, a second light incident surface, and a light emitting surface, the first light incident surface and the second light incident surface intersecting with the light emitting surface respectively;
a plurality of first light guide columns are disposed on the first light incident surface and/or a plurality of second light guide columns are disposed on the second light incident surface, to guide light into the light guide component;
the light emitting surface configured to emit the light.

According to a preferred embodiment of the present disclosure, the first light incident surface is parallel to the second light incident surface.

According to a preferred embodiment of the present disclosure, the plurality of first light guide columns are perpendicular disposed to the first light incident surface, and the plurality of second light guide columns are perpendicular disposed to the second light incident surface.

According to a preferred embodiment of the present disclosure, the first light guide columns are cylindrical, and the second light guide columns are cylindrical.

The present disclosure provides a backlight module, the backlight module comprises a light guide plate and one or more light sources disposed on a side of the light guide plate;
wherein the side-lighting light guide plate comprises a light guide component having a first light incident surface and a light emitting surface that intersects with the first light incident surface;
a plurality of first light guide columns disposed on the first light incident surface to guide light emitted by the one or more light sources into the light guide component;
the light emitting surface configured to emit the light.

According to a preferred embodiment of the present disclosure, a diffusion plate is disposed on a first side of the light guide plate, where the first side has the light emitting surface; a reflective sheet is disposed on a second side far from the diffusion plate of the light guide plate; the reflective sheet, the light guide plate, and the diffusion plate are sequentially stacked.

According to a preferred embodiment of the present disclosure, the light guide component comprises a second light incident surface that intersects with the light emitting surface;
a plurality of second light guide columns disposed on the second light incident surface to guide light into the light guide component;
the light emitting surface configured to emit the light.

Compared to existing side-lighting light guide plate, the present disclosure provides a side-lighting light guide plate that comprises a light guide component having a first light incident surface and a light emitting surface that intersects with the first light incident surface; a plurality of first light guide columns disposed on the first light incident surface to guide light into the light guide component; the light emitting surface configured to emit the light. The side-lighting light guide plate guides light rays into the light guide plate by disposing the light guide columns on the light incident surface of the light guide plate and making the light sources opposite to the incident surface of the light guide columns. The light guide columns guide more light rays and diffuse less light rays making small light area of the light guide plate, better local dimming, high contrast ratio, and less power consumption.

### BRIEF DESCRIPTION OF THE DRAWINGS

FIG. 1 is a structural diagram of backlight module according to the present disclosure.

FIG. 2 is a first structural diagram of light guide plate according to the present disclosure.

FIG. 3 is a second structural diagram of light guide plate according to the present disclosure.

FIG. 4A is a third structural diagram of light guide plate according to the present disclosure.

FIG. 4B is a fourth structural diagram of light guide plate according to the present disclosure.

FIG. 5A is a fifth structural diagram of light guide plate according to the present disclosure.

FIG. 5B is another structural diagram of light guide plate according to the present disclosure.

FIG. 5C is a structural diagram of light source according to the present disclosure.

FIG. 5D is a diagram of light guide plate and light source matched with each other.

### DETAILED DESCRIPTION OF THE PREFERRED EMBODIMENTS

The following description of every embodiment with reference to the accompanying drawings is used to exemplify a specific embodiment which may be carried out in the present disclosure. Directional terms mentioned in the present disclosure, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present disclosure. In the accompanying drawings, units with similar structures are indicated by the same sign.

Also, terms such as “the first” and “the second” are used herein for purposes of description and are not intended to indicate or imply relative importance or significance.

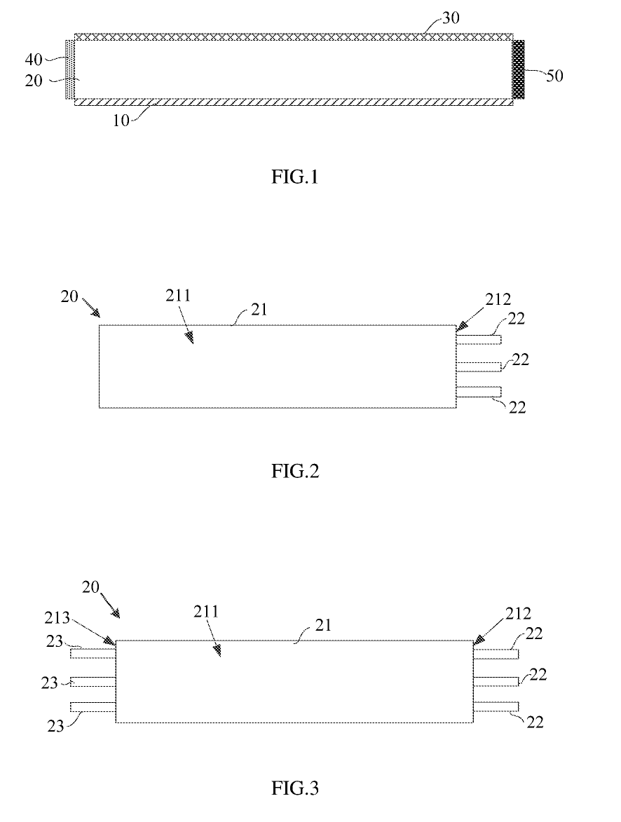

Referring to FIG. 1 and FIG. 2, FIG 1 is a structural diagram of backlight module according to the present disclosure. FIG. 2 is a first structural diagram of light guide plate according to the present disclosure. As shown in FIG. 1, the backlight module comprises a reflective sheet 10, a light guide plate 20, a diffusion plate 30, a shading film 40, and a light source 50.

Specifically, the light guide plate 20 is disposed on the reflective sheet 10. The diffusion plate 30 is disposed on a light emitting surface of the light guide plate 20. The reflective sheet 10, the light guide plate 20, and the diffusion plate 30 are sequentially stacked by sticking or other means. The light source 50 is disposed on a first side of the light guide plate 20, and the shading film 40 is disposed on a second side of the light guide plate 20, where the first side is opposite to the second side.

Referring to FIG. 1, that the light source 50 disposed on the first side can illuminate the light guide plate 20 from one side. According to some embodiments, one light source 50 is disposed on the first side, and another light source 50 instead of the shading film 20, is disposed on the second side to illuminate the light guide plate 20 from two sides.

The reflective sheet 10 is used for reflecting the light rays entering from a surface of the reflective sheet 10. The reflective sheet 10 comprises a transparent plate where a back side can reflect light rays. A front side of the reflective sheet 10 comprises a plurality of composite surfaces having cylindrical surfaces, curved surfaces, and flat surfaces. The cylindrical surfaces incline in a first direction and the curved surfaces incline in a second direction, where the first direction is opposite to the second direction. The cylindrical surfaces and the curved surfaces are disposed continuously, or the plurality of flat surfaces are disposed between the cylindrical surfaces and the curved surfaces. The cylindrical surfaces have a highest proportion of the composite surfaces. A back side of the reflective sheet 10 comprises a plurality of right angle prisms next to each other.

The diffusion plate 30, having its two sides have different refractive indexes by chemical methods or physical methods, can refract, reflect, and scatter light rays. Adding inorganic light scattering materials or organic light scattering materials into the diffusion plate 30, or adjusting order of microstructures of the diffusion plate 30 can help the diffusion plate 30 refract, reflect, and scatter light rays.

The diffusion plate 30 is used for diffusing light. The diffusion plate 30 can be classified as PMMA (polymethylmethacrylate) diffusion plate, PS (polystyrene) diffusion plate, PC (polycarbonate) diffusion plate, and polypropylene (PP) diffusion plate according to constituent materials of the diffusion plate 30.

The shading film 40 makes light rays emitted from the light source 50 not diffuse from the light guide plate 20 preventing light leakage.

According a embodiment, light sources 50 are a plurality of light emitting diodes (LEDs) lights arranged in an array form. LEDs, a kind of semiconductor diodes, can transfer electric energy to luminous energy. A unidirectional LEDs comprises a PN junction like normal emitting diode. A plurality of electron holes from P area to N area and a plurality of electrons from N area to P area are mixed to emit florescent light, after pushing forward voltage to the LEDs. Gallium arsenide diode emits red light. Gallium phosphide diode emits green light. Silicon carbide emits yellow light. Gallium nitride emits blue light. The light emitting diodes are classified to organic light emitting diodes and inorganic light emitting diodes according to chemical nature of the light emitting diodes.

According to the present disclosure, the light guide plate 20 is a flat plate or a deep plate. Continuing to refer to FIG. 2. The light guide plate 20 comprises a light guide component 21 having a light emitting surface 211 and a first light incident surface 212 that intersects with the light emitting surface 211. A plurality of first light guide columns 22 are disposed on the first light incident surface 212 to guide light into the light guide component 21. the light emitting surface 211 is configured to emit the light.

According to some embodiments, the plurality of first light guide columns 22 are perpendicular to the first light incident surface 212 to make light enter the light guide 21 component evenly.

According to some embodiments, the plurality of first light guide columns 22 parallel to the light emitting surface 211 are sequentially arranged on the first light incident surface 212, making light distribute more evenly.

According to some embodiments, the plurality of first light guide columns 22 are disposed along a same interval, making light enter the light guide component 21 more evenly and the light guide plate 20 evenly.

Referring to FIG. 3, FIG. 3 is a second structural diagram of the light guide plate according to the present disclosure. As shown in FIG. 3, the light guide plate 20 not only comprises components as FIG. 2 shows, but also comprises a second light incident surface 213. According to some embodiments, the first light incident surface 212 is parallel and opposite to the second light incident 213. The plurality of first light guide columns 21 and/or a plurality of second light guide columns 23 disposed on the second light incident surface 213, to guide light into the light guide component 21; The light emitting surface 211 is configured to emit the light.

According to some embodiments, the plurality of second light guide columns 23 are perpendicular to the second light incident surface 213 to make light enter the light guide 21 component evenly.

According to some embodiments, the plurality of second light guide columns 23 parallel to the light emitting surface 211 are sequentially arranged on the second light incident surface 213, making light distribute more evenly.

According to some embodiments, the plurality of second light guide columns 23 are disposed along a same interval, making light enter the light guide component 21 more evenly and the light guide plate 20 evenly.

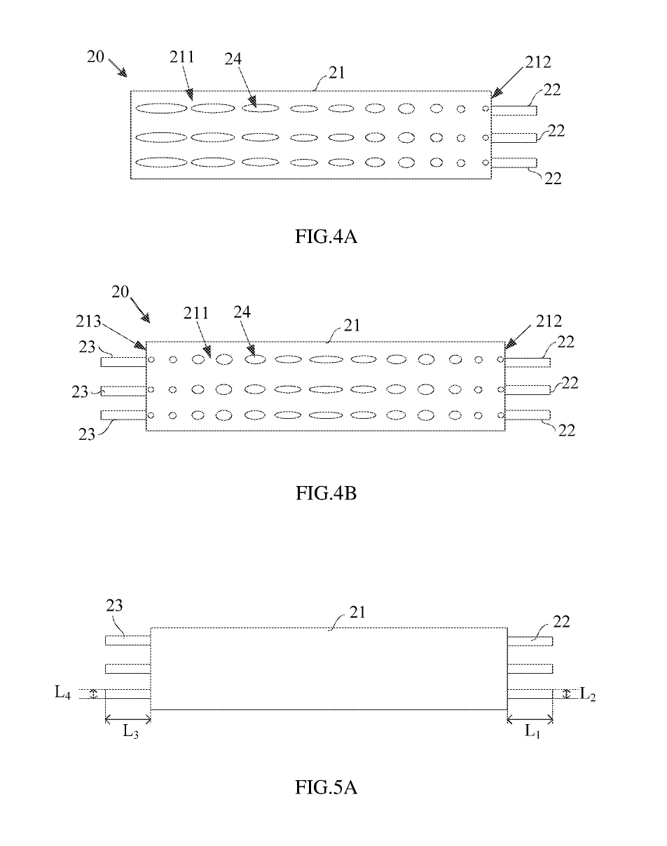

Referring to FIG. 4A and FIG. 4B, FIG. 4A is a third structural diagram of the light guide plate according to the present disclosure. FIG. 4B is a fourth structural diagram of the light guide plate according to the present disclosure. As shown in FIG. 4A and FIG, 4B, the light guide component 21 comprises a plurality of light guide points 24 in an array form. As the light guide plate in FIG. 4B, the light guide points 24 next to the light sources 50 are small, round, and have a long distance with each other. The light guide points 24 in the middle of the light guide plate 20 are big, oval, and have a short distance with each other. Light rays entered from the light guide component 21 are diffuse reflected by the light guide point 24 and penetrate the light guide plate 20 to the light emitting surface 211. The light guide point 24 near the light sources 50 receive more light rays and diffuse reflect more light rays, and the light guide point 24 far away from the light sources 50 receive little light rays and diffuse reflect more light rays, so the light guide plate 20 guides light rays evenly.

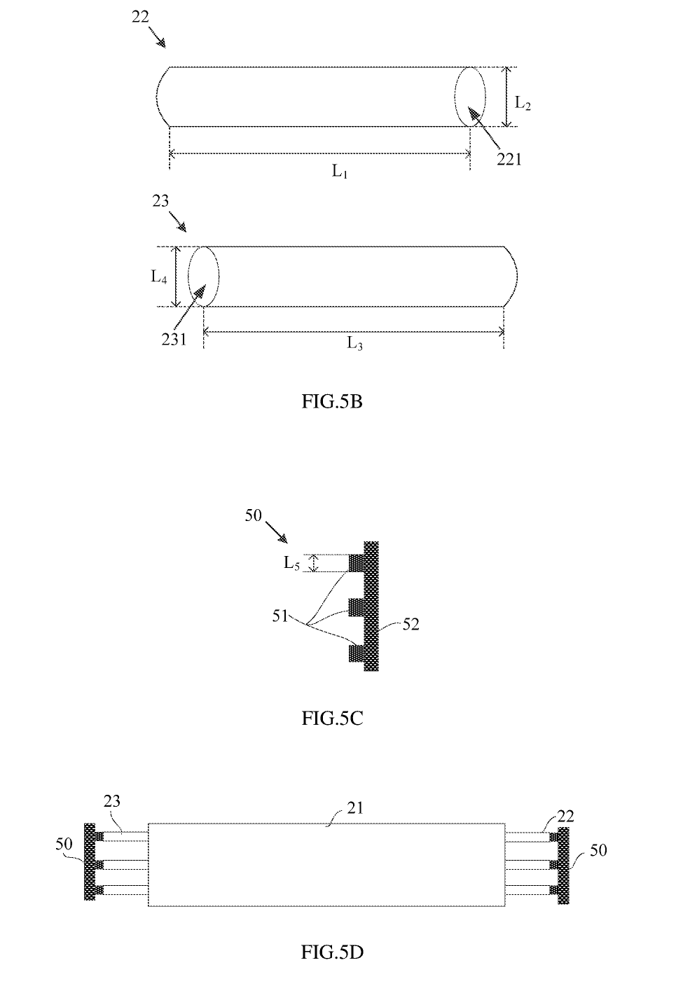

Referring to FIG. 5A and FIG. 5B, both the plurality of first light guide columns 22 and the plurality of second light guide columns 23 are cylindrical as shown in FIG. 5B according to some embodiments.

Both the plurality of first light guide columns 22 and the second light guide columns 23 have other shapes like cuboid, prism and etc, according to other embodiments.

As shown in FIG. 5C, The light sources 50 comprise a plurality of LEDs lights and PCB (Printed Circuit Board) 52 disposing the plurality of LEDs lights and providing power to the plurality of LEDs lights, according to some embodiments.

Referring to FIG. 5D, LEDs lights 51 attach to the light incident surface 221 of the first light guide columns 22 and the light incident surface 231 of the second light guide columns 23 to emit light rays to the light guide component 21, according to some embodiments. Referring to FIG. 5A, a width L₂ of the first light guide column 22 is a little lager than a width L₅ of the LED light 51 to make the light incident surface 221 of the first light guide column 22 cover light emitting surface of the LED light 51. A width L₄ of the second light guide column 22 is a little lager than a width L₅ of the LED light 51 to make the light incident surface 231 of the second light guide column 23 cover light emitting surface of the LED light 51.

Referring to FIG. 5B, a length L₁ of the first light guide column 22 is 5-10 times of a width L₂ of a bottom of the first light guide column 22 to guide light emitted from the light source 50. A length L₃ of the second light guide column 23 is 5-10 times of a width L₄ of a bottom of the second light guide column 23.

The lightback module according to the present disclosure guides light rays into the light guide plate by disposing the light guide columns on the light incident surface of the light guide plate and making the light sources opposite to the incident surface of the light guide columns. The light guide columns guide more light rays and diffuse less light rays making small light area of the light guide plate, better local dimming, high contrast ratio, and less power consumption.

The present disclosure is described in detail in accordance with the above contents with the specific preferred examples. However, this present disclosure is not limited to the specific examples. For a person of ordinary skill in the art, on the premise of keeping the conception of the present disclosure, the technical personnel can also make simple deductions or replacements, all of which should be considered to belong to the protection scope of the present disclosure.

1. A side-lighting light guide plate, wherein the side-lighting light guide plate comprises a light guide component having a first light incident surface and a light emitting surface that intersects with the first light incident surface;
a plurality of first light guide columns disposed on the first light incident surface, to guide light into the light guide component;
the light emitting surface configured to emit the light.

2. The side-lighting light guide plate as claimed in claim 1, wherein the plurality of first light guide columns are perpendicular to the first light incident surface.

3. The side-lighting light guide plate as claimed in claim 1, wherein the plurality of first light guide columns are parallel to the light emitting surface and are sequentially arranged on the first light incident surface.

4. The side-lighting light guide plate as claimed in claim 3, wherein the plurality of first light guide columns are disposed along a same interval.

5. The side-lighting light guide plate as claimed in claim 1, wherein the plurality of first light guide columns are cylindrical.

6. The side-lighting light guide plate as claimed in claim 5, wherein a height of the plurality of first light guide columns is 5-10 times of a diameter of the plurality of first light guide columns.

7. The side-lighting light guide plate as claimed in claim 1, wherein the light guide component has a second light incident surface that intersects with the light emitting surface;
the plurality of first light guide columns and/or a plurality of second light guide columns disposed on the second light incident surface, to guide light into the light guide component;
the light emitting surface configured to emit the light.

8. The side-lighting light guide plate as claimed in claim 7, wherein the first light incident surface is parallel to the second light incident surface.

9. The side-lighting light guide plate as claimed in claim 7, wherein the plurality of second light guide columns are perpendicular to the second light incident surface.

10. The side-lighting light guide plate as claimed in claim 7, wherein the plurality of second light guide columns are parallel to the light emitting surface and are sequential distributed on the second light incident surface.

11. The side-lighting light guide plate as claimed in claim 10, wherein the plurality of second light guide columns are disposed along a same interval.

12. The side-lighting light guide plate as claimed in claim 7, wherein the plurality of second light guide columns are cylindrical.

13. The side-lighting light guide plate as claimed in claim 12, wherein a height of the plurality of second light guide columns is 5-10 times of a diameter of the plurality of second light guide columns.

14. A side-lighting light guide plate, wherein the side-lighting light guide plate comprises a light guide component having a first light incident surface, a second light incident surface, and a light emitting surface, the first light incident surface and the second light incident surface intersecting with the light emitting surface respectively;
a plurality of first light guide columns disposed on the first light incident surface and/or a plurality of second light guide columns disposed on the second light incident surface, to guide light into the light guide component;
the light emitting surface configured to emit the light.

15. The side-lighting light guide plate as claimed in claim 14, wherein the first light incident surface is parallel to the second light incident surface.

16. The side-lighting light guide plate as claimed in claim 15, wherein the plurality of first light guide columns are perpendicular disposed to the first light incident surface, and the plurality of second light guide columns are perpendicular disposed to the second light incident surface.

17. The side-lighting light guide plate as claimed in claim 14, wherein the first light guide columns are cylindrical, and the second light guide columns are cylindrical.

18. A backlight module, wherein the backlight module comprises a light guide plate and one or more light sources disposed on a side of the light guide plate;
wherein the side-lighting light guide plate comprises a light guide component having a first light incident surface and a light emitting surface that intersects with the first light incident surface;
a plurality of first light guide columns disposed on the first light incident surface to guide light emitted by the one or more light sources into the light guide component;
the light emitting surface configured to emit the light.

19. The backlight module as claimed in claim 18, wherein a diffusion plate is disposed on a first side of the light guide plate, where the first side has the light emitting surface; a reflective sheet is disposed on a second side far from the diffusion plate of the light guide plate; the reflective sheet, the light guide plate, and the diffusion plate are sequentially stacked.

20. The backlight module as claimed in claim 18, wherein the light guide component comprises a second light incident surface that intersects with the light emitting surface;
a plurality of second light guide columns disposed on the second light incident surface to guide light into the light guide component;
the light emitting surface configured to emit the light.
